(19) United States
(12) Patent Application Publication
(10) Pub. No.: US 2012/0262915 A1
(43) Pub. Date: Oct. 18, 2012

(54) LED (LIGHT-EMITTING DIODE) LAMP WITH LIGHT REFLECTION

(75) Inventors: Ching Feng LIN, Taipei County (TW); Yung Han, Taipei County (TW)

(73) Assignee: JADE YANG CO., LTD., New Taipei City (TW)

(21) Appl. No.: 13/088,721

(22) Filed: Apr. 18, 2011

(51) Int. Cl. F21V 7/04

(52) U.S. Cl. 362/235

(57) ABSTRACT

The present invention is primarily related to a LED (Light-Emitting Diode) lamp with light reflection, which provides both the forward and the backward illumination via the configuration of reflection plate with one side or both sides regularly distributed with a plurality of protruding or hollow geometric spatial blocks, for example, pyramids or cones to enable both light transparency and reflection, and thus enlarges the practical space of prior LED lamp illumination and provides more utility and convenience.

### BACKGROUND OF THE INVENTION

1. Field of the Invention

The present invention is generally relates to a LED (Light-Emitting Diode) lamp with light reflection, which comprises a lamp that is composed of a base, an electrical connector and a circuit board, wherein the base is fixed connecting with the electrical connector, and the base is at one end configured with a circuit board which is installed with a plurality of LED and is electrically connected with the electrical connector; a transparent lamp cover, set up over the base and the circuit board, which has an opening at the front end; and a reflection plate, configured with the said opening, is light transparent and regularly distributed at one side or both sides with a plurality of protruding or hollow geometric spatial blocks, for example, pyramids or cones which allow both light transparency and reflection to enable the present invention not only performs the forward illumination but also equips with a function of backward illumination via the structure configured at the reflection plate. Therefore, the present invention can enlarge the practical space of illumination and provide more utility and convenience.

2. Description of Related Art

LED (Light-Emitting Diode) had been known as a popular illumination component which features power saving, small size, quick response and environmental protection, and was common adopted at various illumination products. Recent years, LED lamp had been applied in the field of illumination equipment and had taken the place of traditional lamps. Generally, LED lamp comprises a connector, a base configured with a circuit board which is installed with a plurality of LED and is electrically connected with the electrical connector. There is usually a transparent lamp cover installed at the top of the base and the circuit board. When the lamp is connected with the power, the LEDs start to perform the forward illumination only via the original transparent lamp cover. However, due to the original lamp structure, it is not applicable to provide a back illumination toward the space behind the LED lamp. Under such a circumstance, the prior art of LED illumination could not afford to offer sufficient lighting function needs to be improved. That is the main purpose the present invention aims to provide an innovation and a better solution for LED lamp.

### SUMMARY OF THE INVENTION

The primary objective of the present invention is to provide a LED (Light-Emitting Diode) lamp with light reflection, which comprises a lamp that is composed of a base, an electrical connector and a circuit board, wherein the base is fixed connecting with the electrical connector, and the base is at one end configured with a circuit board which is installed with a plurality of LED and is electrically connected with the electrical connector; a transparent lamp cover, set up over the base and the circuit board, which has an opening at the front end; and a reflection plate, configured with the said opening, is light transparent and is regularly distributed at one side or both sides with a plurality of protruding or hollow geometric spatial blocks, for example, pyramids or cones which allow both light transparency and reflection to enable the present invention not only performs the forward illumination but also equips with a function of backward illumination via the structure configured at the reflection plate to enhance more utility and convenience.

Another objective of the present invention is to provide a LED (Light-Emitting Diode) lamp with light reflection, wherein the reflection plate configured at the opening of the transparent lamp cover is embodied with different colors according to the size and the area adopted on the surface of the transparent lamp cover. That is, the shape, the color, the size and the number of the reflection plate is modifiable depends on the practical necessity. The reflection plate is not necessarily to be configured at the symmetric center on the surface of the transparent lamp cover. Thus, it also increases a multi application of the present invention.

A further objective of the present invention is to provide a LED (Light-Emitting Diode) lamp with light reflection, wherein the reflection plate and the transparent lamp cover can be made of those recycled transparent material and formed as a whole body. It increases the manufacturing efficiency and also strengthens the concept of environmental protection. As the present invention can adopt the recycled transparent material, the lower cost and the more popularity prove the present invention is indeed a valuable solution toward those traditional LED lamps.

### BRIEF DESCRIPTION OF THE DRAWINGS

To enable a further understanding of the said objectives and the technological methods of the invention herein, the brief description of the drawings below is followed by the detailed description of the preferred embodiments.

FIG. 1 is a 3-dimensional diagram of an embodiment according to the present invention; and

FIG. 2 is an exploded diagram related to the components of the present invention.

FIG. 3 is a schematic view demonstrates the light reflection of the present invention.

1 [symbol] electric connector

2 [symbol] base

21 [symbol] radiation fin

3 [symbol] circuit board

31 [symbol] LED (Light Emitting Diode)

4 [symbol] transparent lamp cover

41 [symbol] opening

5 [symbol] reflection plate

51 [symbol] geometric spatial block

### DETAILED DESCRIPTION OF THE PREFERRED EMBODIMENTS

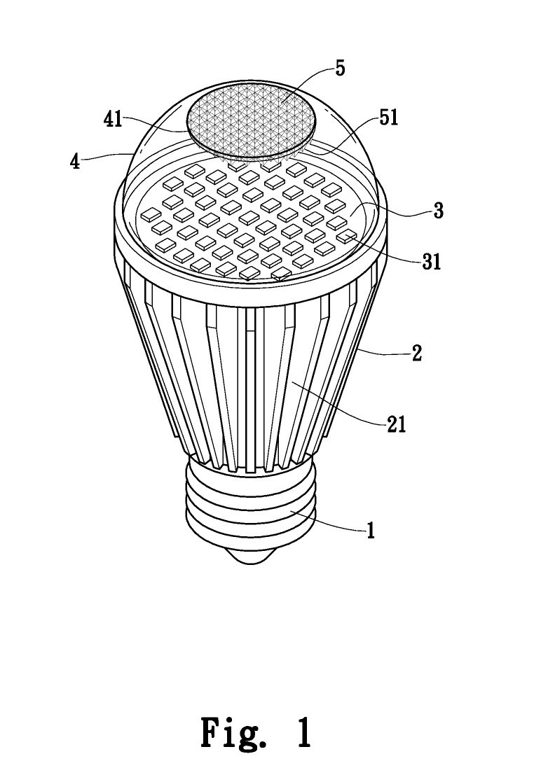

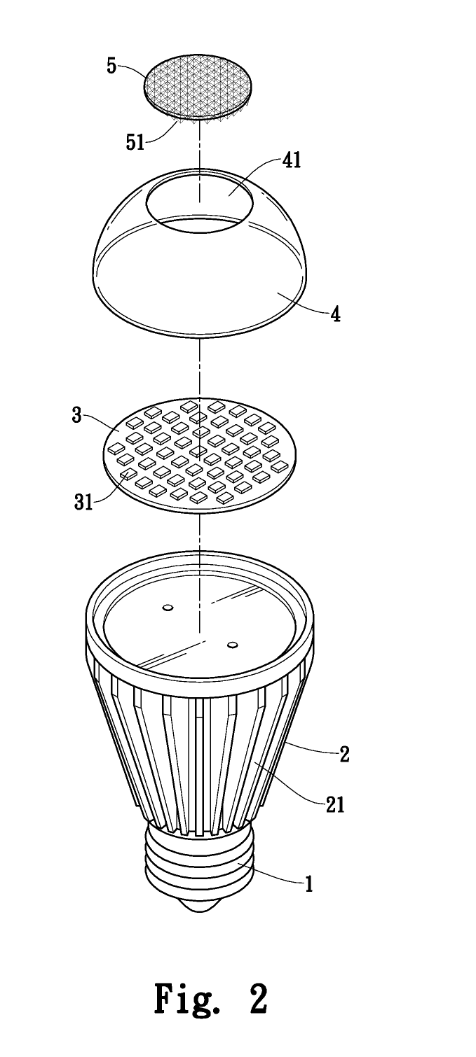

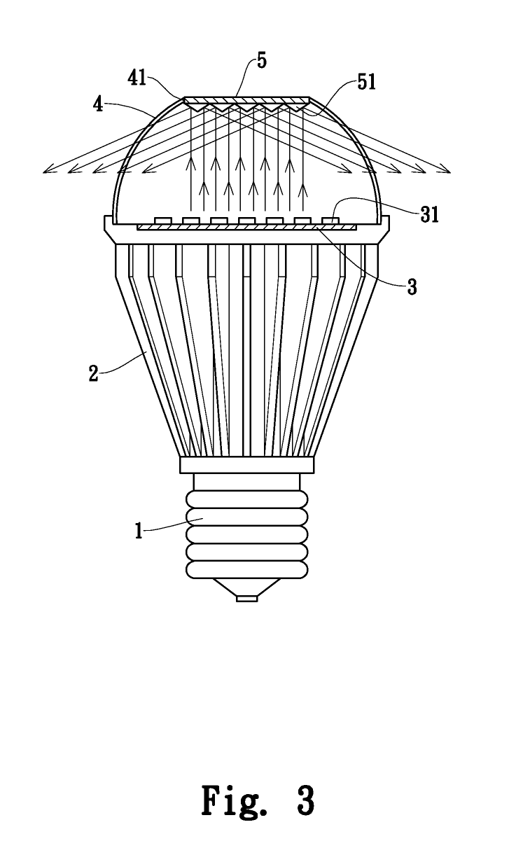

Please refer to FIGS. 1, 2 and 3, which respectively show a 3-dimensional diagram, a components exploded diagram and a schematic view of the light reflection of the present invention. The present invention, a LED (Light-Emitting Diode) lamp with light reflection, comprises:
a lamp, that is composed of an electrical connector 1, a base 2, and a circuit board 3, wherein the base 2 is fixed connecting with the electrical connector 1 and is installed with a plurality of radiation fins 21 around the circumference, and the base 2 is at one end configured with a circuit board 3 which is installed with a plurality of LEDs 31 and is electrically connected with the electrical connector 1;
a transparent lamp cover 4, set up over the base 2 and the circuit board 3, which has an opening 41 at the front end; and
a reflection plate 5, configured with the said opening 41 at the front end of the transparent lamp cover 4, is light transparent and is regularly distributed at one side or both sides with a plurality of protruding or hollow geometric spatial blocks 51, for example, pyramids or cones which allow both light transparency and reflection to enable the present invention not only performs the forward illumination but also equips with a function of backward illumination via the structure configured at the reflection plate 5 to enhance more utility and convenience. The plurality of protruding or hollow geometric spatial blocks 51 can be configured as a manner of array distribution. The said transparent lamp cover 4 can be in a shape of a sphere, a cone or a column. Furthermore, the reflection plate 5 can adopt the recycled transparent material and formed with the transparent lamp cover 4 as a whole body.

Besides, the reflection plate 5 configured at the opening 41 of the transparent lamp cover 4 can be embodied with different colors according to the size and the area adopted on the surface of the transparent lamp cover 4. In other words, the shape, the color, the size or the number of the reflection plate 5 is modifiable depends on the practical necessity. The reflection plate is not necessarily to be configured at the symmetric center on the surface of the transparent lamp cover 4. Thus, it also increases a multi application of the present invention.

Additionally, there is another solution for the present invention to carry out both light transparency and reflection. That is, the reflection plate 5 is replaced by paint, coated on the surface by different size or color, which affords both light transparency and reflection.

However, the above mentioned description are only some better embodiments of the present invention which shall not be used to limit the scope of the present invention and any equivalent change or revision based on the current invention should all be included in this invention.

What is claimed is:

1. A LED (Light-Emitting Diode) lamp with light reflection, comprising:
a lamp, which is composed of a base, an electrical connector and a circuit board, wherein the base is fixed connecting with the electrical connector and is installed with a plurality of radiation fins around the circumference, and the base is at one end configured with a circuit board which is installed with a plurality of LED and is electrically connected with the electrical connector;
a transparent lamp cover, set up over the base and the circuit board, which has an opening at the front end; and
a reflection plate, configured with the said opening, is light transparent and is regularly distributed at one side or both sides with a plurality of protruding or hollow geometric spatial blocks.

2. A LED lamp with light reflection according to claim 1, wherein the plurality of protruding or hollow geometric spatial blocks are pyramids.

3. A LED lamp with light reflection according to claim 1, wherein the plurality of protruding or hollow geometric spatial blocks are cones

4. A LED lamp with light reflection according to claim 1, wherein the reflection plate configured at the opening can be modified by different colors, size, number or the area embodied on the surface of the transparent lamp cover.

5. A LED lamp with light reflection according to claim 1, wherein the reflection plate is replaced by paint, coated on the surface by different size or color, which affords both light transparency and reflection.

6. A LED lamp with light reflection according to claim 1, wherein the reflection plate and the transparent lamp cover is made of recycled transparent material and formed as a whole body.

7. A LED lamp with light reflection according to claim 1, wherein the plurality of protruding or hollow geometric spatial blocks is configured as a manner of array distribution.
